(19) United States
(12) Patent Application Publication
(10) Pub. No.: US 2010/0178405 A1
(43) Pub. Date: Jul. 15, 2010

(54) BEVERAGE BREWING SYSTEM SELECTIVELY USING ONE OR MORE CARTRIDGES

(76) Inventor: BARBARA L. SCHNABEL, Chappaqua, NY (US)

Correspondence Address: Lawrence Cruz;Conair Corporation, One Cummings Point Road, STAMFORD, CT, 06902, US

(21) Appl. No.: 12/627,672

(22) Filed: Nov. 30, 2009

Related U.S. Application Data
(60) Provisional application No. 61/119,555, filed on Dec. 3, 2008.

(51) Int. Cl. A23F 5/26; A47J 31/40

(52) U.S. Cl. 426/433

(57) ABSTRACT

A novel beverage brewing system includes a plurality of beverage cartridge holders so that a user may selectively choose to infuse heated liquid through one or more cartridges of beverage medium (i.e., coffee grounds). One or more diverter valves may be used to achieve this. For weaker brewed coffee, a user would select a setting in which heated water passes through only one cartridge and then into a container. For stronger coffee, a setting would be chosen in which the heated water passes through both cartridges and then into the container. Alternatively, water from both cartridges could be diverted into two containers to brew weak coffee into two containers at the same time.

### CROSS-REFERENCE TO RELATED APPLICATIONS

This application is related to and claims priority from U.S. Provisional Application No. 61/119555 filed on 3 Dec. 2008.

### BACKGROUND OF THE INVENTION

1. Field of the Invention

The present invention relates to beverage appliances and, more particularly, to electrically powered beverage brewing appliances.

2. Description of Related Art

Various methods and appliances exist for brewing coffee or other hot beverages using a commercially available disposable cartridge in an electrically heated appliance. Known appliances of this type have a single holder for the disposable cartridge, wherein the cartridge is pierced and hot liquid is introduced into the cartridge and infused with the beverage medium (i.e., coffee grounds) and extracted to a separate container for consumption.

Because the cartridge has a fixed amount of medium, the strength of the beverage is regulated by the amount of hot liquid that passes through the cartridge (lower volume for stronger beverage; higher volume for weaker beverage). Thus, the single cartridge restricts the volume/strength of the brewed beverage.

### OBJECTS OF THE PRESENT INVENTION

It is an object of the present invention to provide a beverage brewing system of the type described above but that also provides a convenient and effective way to choose and selectively regulate strength of the brewed beverage.

These and other objects are achieved by the present invention.

### SUMMARY OF THE INVENTION

A novel beverage brewing system includes a plurality of beverage cartridge holders so that a user may selectively choose to infuse heated liquid through one or more cartridges of beverage medium (i.e., coffee grounds). One or more diverter valves may be used to achieve this. In a preferred embodiment, there are two cartridge holders. For weaker brewed coffee, for example, a user would select a setting in which heated water passes through only one cartridge and then into a container. For stronger coffee, a setting would be chosen in which the heated water passes through both cartridges and then into the container. Alternatively, water from both cartridges could be diverted into two containers to brew weak coffee into two containers at the same time. More than two cartridges and corresponding holders and valves could be used to achieve even stronger coffee or more containers of weak coffee at the same time. Additionally, various holders and cartridges could be used to infuse flavorings, additives and other substances

### BRIEF DESCRIPTION OF THE DRAWINGS

None.

### DESCRIPTION OF THE PREFERRED EMBODIMENT OF THE INVENTION

According to the present invention, a novel beverage brewing system includes a plurality of beverage cartridge holders so that a user may selectively choose to infuse heated liquid through one or more cartridges of beverage medium (i.e., coffee grounds). One or more diverter valves are used to achieve this. In a preferred embodiment, two cartridge holders exist. For weaker brewed coffee, for example, a user would select a setting in which heated water passes through only one cartridge and then into a container. For stronger coffee, a setting would be chosen in which the heated water passes through both cartridges and then into the container. Alternatively, water from both cartridges could be diverted into two containers to brew weak coffee into two containers at the same time. More than two cartridges and corresponding holders and valves could be used to achieve even stronger coffee or more containers of weak coffee at the same time. Additionally, various holders and cartridges could be used to infuse flavorings, additives and other substances.

While the preferred embodiment of the invention has been described herein, various modifications may be made without departing from the scope of the present invention.

What is claimed is:

1. A method of brewing coffee, said method comprising
heating water;
causing said water to pass through a first beverage medium;
selectively causing said water to either pass through a second beverage medium or to bypass said second beverage medium; and
causing said water to exit into a first container.

2. A method according to claim 1, further comprising
causing said water to exit into a second container.

3. A method according to claim 1, further comprising
causing said water to exit into said first container after passing through one of said first cartridge and said second cartridge.

4. A method according to claim 1, further comprising
causing said water to exit into said first container after passing through both of said first cartridge and said second cartridge.

5. A method according to claim 1, further comprising
causing some of said water to exit into said first container after passing through said first cartridge only, and causing some of said water to exit into said second container after passing through said second cartridge only.
